(19) United States
(12) Patent Application Publication
(10) Pub. No.: US 2011/0151145 A1
(43) Pub. Date: Jun. 23, 2011

(54) CELLULOSE ESTER FILM, POLARIZING PLATE, AND LIQUID CRYSTAL DISPLAY

(75) Inventors: Kazuo KAMOHARA, Kanagawa (JP); Hiroaki SATA, Kanagawa (JP); Ryo SUZUKI, Kanagawa (JP)

(73) Assignee: FUJIFILM CORPORATION, Tokyo (JP)

(21) Appl. No.: 12/969,066

(22) Filed: Dec. 15, 2010

(30) Foreign Application Priority Data
Dec. 18, 2009 (JP) 2009-288260

(51) Int. Cl. C09K 19/52; B32B 23/20; G02B 1/10; B29D 7/01; C09D 101/10

(52) U.S. Cl. 428/1.33; 428/220; 264/218; 106/170.26

(57) ABSTRACT

A cellulose ester film is provided and includes a non-phosphoric acid additive. The cellulose ester film has: a degree of alignment of 0.12 or higher in a thickness direction of the cellulose ester film as measured by wide angle X-ray diffractometry; and an average elastic modulus of 3.7 to 4.5 GPa.

This application is based on and claims priority under 35 U.S.C. §119 from Japanese Patent Application No. 2009-288260, filed Dec. 18, 2009, the entire disclosure of which is herein incorporated by reference.

### BACKGROUND OF THE INVENTION

1. Field of the Invention

This invention relates to a cellulose ester film, a polarizing plate, and a liquid crystal display (LCD).

2. Background Art

Cellulose ester films have been used as a photographic and an optical material because of their toughness and flame retardancy. They recently find frequent use as optical films for LCDs. Having optically high transparency and optically high isotropy, cellulose ester films are superior as optical materials for use in devices involving light polarization such as LCDs. For example, they have been used as a protective film for a polarizer of a polarizing plate or a substrate of an optical compensation film that improves the display seen from oblique directions (viewing angle compensation film).

A polarizing plate, one of the elements constituting an LCD, is composed of a polarizer and a protective film bonded to at least one side of the polarizer. A commonly employed polarizer is obtained by staining a stretched polyvinyl alcohol (PVA) film with iodine or a dichroic dye. In many cases, a cellulose ester film that can be bonded directly to a PVA film on the same production line, particularly a cellulose acetate film has been used as a polarizer protective film.

For use as a polarizer protective film on the viewer's side, a cellulose ester film must have surface hardness enough to secure scratch resistance. In order to establish sufficient surface hardness, addition of a high hardness additive (as taught in WO 02/059192) and film modification by stretching have been proposed. Stretching film prevails as a means for adjusting optical performance and meeting the demands for web spreading and thinning from the viewpoint of material cost reduction.

When the above described techniques are adopted, however, there arises a problem that workability of the polarizing plate deteriorates. For example, when cut to size, the polarizing plate may undergo cracking or delamination between the polarizer and the protective film at the cut edge. This problem has been dealt with by, for example, polishing the cut edges of the polarizing plate. Nevertheless, the edge polishing treatment is not carried out in many cases depending on the intended use of the polarizing plate, in which cases occurrence of cracking or delamination makes the polarizing plate useless. Besides, it is desirable to exclude the necessity of the edge polishing treatment from the standpoint of cost reduction.

Adding a plasticizer to a cellulose ester film generally reduces the elastic modulus to improve the workability of the film. However, stretching the film can fail to sufficiently improve workability because the stretching brings about an increase in degree of alignment.

The amount of a plasticizer to be added could be increased to solve the above problem, but there is a limit to the amount of a plasticizer that may be added without inducing the potential bleed-out problem. In addition, phosphoric acid plasticizers that have been commonly used for cellulose ester films involve the problem of poor endurance under severe high temperature and humidity conditions and the problem of poor yield attributed to precipitation and volatilization during the film production.

WO 05/061595 proposes using an ester plasticizer having an aliphatic main chain terminated with an aromatic group in place of a phosphoric acid plasticizer to prevent a stretched cellulose ester film from breaking during the film formation.

Among the characteristics relating to the surface hardness of film is elastic modulus. For example, JP 2001-055402A below discloses a cellulose ester film containing a polysaccharide and having a tensile elastic modulus of 340 kgf/mm² (=13.4 GPa) or more.

WO 05/061595 is silent to workability of a polarizing plate. As a result of the present inventors' study, it has been revealed that, when the cellulose ester film of WO 05/061595, which does not break during film formation, is joined with a polarizer, there are cases where the resulting polarizing plate has poor workability. That is, it is difficult with the plasticizer of WO 05/061595 to obtain both workability of a polarizing plate and surface hardness. Furthermore, applying a cellulose ester film containing the additive proposed in WO 05/061595 to a polarizing plate causes reduction of polarizing performance under hot and humid conditions, raising the problem of durability of the resulting polarizing plate.

JP 2001-055402A discusses tensile elastic modulus but neither suggests a specific connection to surface hardness nor mentions workability of a polarizing plate.

### SUMMARY OF THE INVENTION

An object of the invention is to provide a cellulose ester film that has high surface hardness and, when used as a polarizer protective film, provides a polarizing plate exhibiting good workability and durability. Another object of the invention is to provide an LCD having the cellulose ester film or the polarizing plate.

As a result of investigation, the present inventors have revealed that an additive material which is of non-phosphoric acid type and yet effective in reducing elastic modulus like a phosphoric acid type plasticizer to improve workability of film is unexpectedly scarce.

They have found that an aliphatic additive known to be effective in reducing elastic modulus is liable to deteriorate durability of a polarizing plate and therefore difficult to use in practice.

As a result of further investigation, the inventors have found that a cellulose ester film containing a non-phosphoric acid additive and having a specific degree of alignment and a specific elastic modulus provides a polarizing plate having both high surface hardness and good workability as well as excellent durability. They have also specified a non-phosphoric acid type additive that is appropriate to control degree of alignment and elastic modulus of a cellulose ester film within desired ranges.

The objects can be achieved by the following means.

[1] A cellulose ester film comprising a non-phosphoric acid additive,

wherein the cellulose ester film has: a degree of alignment of 0.12 or higher in a thickness direction of the cellulose ester film as measured by wide angle X-ray diffractometry; and an average elastic modulus of 3.7 to 4.5 GPa.

[2] The cellulose ester film as described in [1], wherein the non-phosphoric acid additive is a trimellitic ester.
[3] The cellulose ester film as described in [1] or [2], wherein the non-phosphoric acid additive has a molecular weight of 350 or more.
[4] The cellulose ester film as described in any one of [1] to [3], wherein an amount of the non-phosphoric acid additive is 5 to 25% by mass based on the cellulose ester.
[5] The cellulose ester film as described in any one of [1] to [4], wherein the degree of alignment in the thickness direction of the cellulose ester film is 0.12 to 0.15.
[6] The cellulose ester film as described in any one of [1] to [5], which has a thickness of 10 to 80 μm and a width of 1400 to 4000 mm.
[7] The cellulose ester film as described in any one of [1] to [6], which has retardations Re and Rth, which are defined by formulae (1) and (2), at a wavelength of 590 nm falling within respective ranges (3) and (4):

Re=(nx−ny)×d (1)

Rth={(nx+ny)/2−nz}×d (2)

0≦Re≦5 (3)

20≦Rth≦50 (4)

wherein nx is a refractive index in a direction of a slow axis in a plane of the cellulose ester film; ny is a refractive index in a direction of a fast axis in the plane of the cellulose ester film; nz is a refractive index in a thickness direction of the cellulose ester film; and d is a thickness of the cellulose ester film.
[8] The cellulose ester film as described in any one of [1] to [7], which comprises a cellulose acylate having a degree of acyl substitution of 2.80 to 2.96.
[9] A process for producing a cellulose ester film described in any one of [1] to [8], comprising forming a film from a solution containing a cellulose ester and a non-phosphoric acid additive on a metal substrate having a surface temperature of 0° C. or lower.
[10] The process as described in [9], further comprising stretching the film 1.15 to 1.4 times in a direction perpendicular to a film moving direction.
[11] A polarizing plate comprising a polarizer and protective films on respective sides of the polarizer, at least one of the protective films being a cellulose ester film described in any one of [1] to [8].
[12] A liquid crystal display comprising a liquid crystal cell and two polarizing plates on respective sides of the liquid crystal cell, at least one of the two polarizing plates being the polarizing plate described in [11].

### DETAILED DESCRIPTION OF THE INVENTION

A cellulose ester film according to an exemplary embodiment of the invention has high surface hardness and, when applied as a polarizer protective film, provides a polarizing plate with excellent workability and durability. A polarizing plate according to an exemplary embodiment of the invention is excellent in surface hardness, workability, and durability. Also, according to an exemplary embodiment of the invention, it is possible to provide an LCD having the cellulose ester film or the polarizing plate.

Hereinafter, the invention will be described in detail. In the present specification, when numerical values represent material properties or the like, “(numerical value 1) to (numerical value 2)” and “from (numerical value 1) to (numerical value 2)” represent the meaning of “not less than (numerical value 1) and not more than (numerical value 2)”. Further, “Ck-Cl group” means that the number of carbon atoms in the group is from k to l.

A cellulose ester film according to an exemplary embodiment of the invention is a film of a cellulose ester containing a non-phosphoric acid additive and has a degree of alignment of 0.12 or higher in its thickness direction as measured by wide angle X-ray diffractometry (WAXD), and an average elastic modulus of 3.7 to 4.5 GPa.

When used as a protective film of a polarizing plate, a cellulose ester film having a high degree of alignment (of about 0.12 or higher) tends to deteriorate workability of the polarizing plate. Accordingly, it is a general practice to use a protective film with a low degree of alignment in order to secure both surface hardness and workability of the resulting polarizing plate. In the present invention, in contrast, a film exhibiting high surface hardness and providing a polarizing plate having good workability is obtained even with a degree of alignment of 0.12 or higher by using a non-phosphoric acid additive and by controlling the average elastic modulus within a specific range.

The degree of alignment, in thickness direction, of a cellulose ester film is measured by WAXD. Specifically, an X-ray diffractometer RAPID R-AXIS from Rigaku Corp. is used for the measurement. The film is irradiated on its edge surface with X-ray from CuKa radiation, and an intensity distribution at a prescribed 20 angle was measured by the transmission method, from which the degree of alignment is calculated.

When the degree of alignment in the film thickness direction is less than 0.12, sufficient surface hardness is not obtained. The degree of alignment in the film thickness direction is preferably in the range of from 0.12 to 0.15. The degree of alignment is adjusted by, for example, stretching conditions (e.g., a stretch ratio) and the kind and amount of the additive to be added. Examples of embodiments with respect to a preferred stretch ratio, a preferred additive, and a preferred amount of the additive for controlling the degree of alignment within the range recited include the stretch ratio described as below and the non-phosphoric acid additive and its amount described as below.

A cellulose ester film of the invention has an average elastic modulus of 3.7 to 4.5 GPa. With an average elastic modulus of 3.7 GPa or more, a high surface hardness is obtained. With an average elastic modulus of 4.5 GPa or less, the resulting polarizing plate exhibits good workability. The average elastic modulus of the film is preferably in the range of from 3.9 to 4.3 GPa.

As used herein, the term “average elastic modulus” of a cellulose ester film is an average of tensile elastic modulus values in any two in-plane directions. The tensile elastic modulus in each direction is measured using a Tensilon tensile tester (RTA-100, from Orientec) in accordance with ISO1184 1983. Specifically, the measurement is taken in a 25° C. and 60R RH atmosphere to obtain a load-strain curve, from which a tensile elastic modulus is calculated. The two directions of the measurement are not particularly limited and include, for example, the transverse direction (TD) of the film and a direction perpendicular to TD, i.e., the machine direction (MD) that corresponds to the moving direction of the film being produced. While the tensile elastic modulus in each direction is not particularly limited as long as the average of the two directions falls within the range recited, it is preferred for the tensile elastic modulus in MD be from 3.5 to 4.3 GPa, more preferably 3.7 to 4.2 GPa, and for that in TD be from 3.7 to 4.8 GPa, more preferably 4.0 to 4.7 GPa.

The average elastic modulus of the film may be adjusted by, for example, the kind and amount of the additive. Examples of embodiments with respect to a preferred additive and a preferred amount of the additive for adjusting the average elastic modulus within the range recited include the non-phosphoric acid additive and its amount described as below.

The cellulose ester film of the invention contains a non-phosphoric acid additive. Examples of the non-phosphoric acid additive include trimellitic esters, citric esters, sugar esters, and ester copolymers obtained from a dibasic acid and a diol and having an aromatic ring or a hetero ring. Trimellitic esters are preferred. Of the trimellitic esters preferred are those formed between trimellitic acid and a C4-C10 alcohol, such as tributyl trimellitate, tri(2-ethylhexyl) trimellitate, tri(n-octyl) trimellitate, tri(n-decyl) trimellitate, and triisodecyl trimellitate. Inter alia, tributyl trimellitate and triisodecyl trimellitate are preferred.

If an additive vaporizes during the cellulose ester film formation, the vapor of the additive can cause the production equipment to malfunction or deteriorate the film surface condition. In order to prevent vaporization of the additive, it is desirable for the non-phosphoric acid additive to have a molecular weight of at least 350, preferably 400 or greater, more preferably 500 or greater. In the case of a trimellitic ester, a preferred molecular weight is 380 to 700.

The amount of the non-phosphoric acid additive in the cellulose ester film is preferably 5% to 25%, more preferably 5% to 20%, even more preferably 5% to 15%, by mass based on the cellulose ester. With 5% or more of the non-phosphoric acid additive, improvement in workability of the resulting polarizing plate is secured. With 25% or less of the non-phosphoric acid additive, sufficient surface hardness is obtained, and the resulting polarizing plate has improved durability.

Examples of the cellulose ester of the cellulose ester film include cellulose ester compounds and compounds having an ester-substituted cellulose skeleton which is obtained from cellulose by biologically or chemically introducing a functional group.

The cellulose ester is an ester between cellulose and an acid. The acid is preferably an organic acid, more preferably a carboxylic acid, even more preferably a C2 to C22 carboxylic acid (preferably a C2 to C22 fatty acid), most preferably a C2-C4 lower fatty acid.

Cellulose that can be used as a raw material of the cellulose acylate for use in the invention is not particularly limited. Any cellulose material, such as cotton linter or wood pulp (either hardwood or softwood pulp), may be used. A mixture of different raw cellulose materials may be used in some cases. For the details of the raw cellulose materials, reference may be made in Marusawa and Uda, Plastic Zairyo Koza (17) Sen'isokei Jyushi, The Nikkan Kogyo Shimbun, Ltd., 1970 and Journal of Technical Disclosure 2001-1745, Japan Institute of Invention and Innovation, pp. 7-8.

The cellulose acylate that is suitably used in the invention will be described in more detail. The cellulose acylate preferred for use in the invention is cellulose with its hydroxyl groups acylated with an acyl group having 2 (=acetyl) to 22 carbon atoms. The degree of acyl substitution of the hydroxyl groups of cellulose is not particularly limited. The degree of acyl substitution is calculated by determining the degree of bonding of acetic acid and/or other C3-C22 carboxylic acids in substitution for the hydrogen atom of the hydroxyl group(s) of cellulose in accordance with, for example, ASTM D-817-91.

The degree of acyl substitution of the cellulose acylate is preferably 2.70 to 2.96, more preferably 2.80 to 2.96.

A degree of acyl substitution of 2.70 or higher is preferred in terms of workability and durability of the polarizing plate. A cellulose acylate having a degree of acyl substitution of 2.96 or lower has advantages of good solubility in organic solvents and good compatibility with additives.

The C2-C22 acyl group or groups substituting the hydrogen atom of the hydroxyl groups of cellulose which is/are derived from acetic acid and/or a C3-C22 carboxylic acid may be either aliphatic or aromatic and may be of a single kind or a mixture of two or more acyl groups. The acyl group may be, for example, an alkylcarbonyl ester group, an alkenylcarbonyl ester group, an aromatic carbonyl ester group, or an aromatic alkylcarbonyl ester group, each of which may further be substituted. Examples of preferred acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, t-butanoyl, cyclohexanecarbonyl, oleoyl, benzoyl, naphthylcarbonyl, and cinnamoyl. More preferred of them are acetyl, propionyl, butanoyl, dodecanoyl, octadecanoyl, t-butanoyl, oleoyl, benzoyl, naphthylcarbonyl, and cinnamoyl. Even more preferred are acetyl, propionyl, and butanoyl. Particularly preferred are acetyl and propionyl. Acetyl is the most preferred.

When the hydrogen atom of the hydroxyl groups of cellulose are substituted substantially with at least two of acetyl, propionyl, and butanoyl groups, the total degree of substitution with these groups is preferably 2.70 to 2.96, more preferably 2.80 to 2.96. When the hydrogen atom of the hydroxyl groups are substituted with only an acetyl group, the degree of acetyl substitution is preferably 2.70 to 2.96, more preferably 2.80 to 2.96.

The cellulose acylate preferably used in the invention preferably has a degree of polymerization of 180 to 700 in terms of viscosity average degree of polymerization. In the case of cellulose acetate, the degree of polymerization is preferably 180 to 550, more preferably 180 to 400, even more preferably 180 to 350. Unless the degree of polymerization exceeds the upper limit recited above, the cellulose acylate solution (also referred to as a dope) will not be too viscous to be cast in film formation. With the degree of polymerization being not lower than the recited lower limit, inconvenience such as reduction of film strength will not be experienced. The viscosity average degree of polymerization may be determined by intrinsic viscosity method (Kazuo Uda and Hideo Saito, Sen'i Gakkaishi, vol. 18, No. 1, pp. 105-120, 1962). The details of this method are described in JP 9-95538A.

The molecular weight distribution of the cellulose acylate used in the invention is preferably as narrow as possible. The molecular weight distribution is typically evaluated by polydispersity index defined to be the ratio of mass average molecular weight to number average molecular weight as determined by gel permeation chromatography. The polydispersity index is preferably 1.0 to 4.0, more preferably 2.0 to 4.0, even more preferably 2.3 to 3.4.

While the cellulose acylate film of the invention may be produced by any method, it is preferably produced by a solvent casting process using a solution (called a dope) of a cellulose acylate in an organic solvent.

The organic solvent that can be used to prepare a cellulose acylate dope may be a chlorine-containing solvent system comprising a chlorine-containing organic solvent as a main solvent or a chlorine-free solvent system containing no chlorine-containing organic solvent. Two or more organic solvents may be used as a mixture.

A chlorine containing organic solvent is preferably used as a main solvent in the preparation of a cellulose acylate solution. Any chlorine containing organic solvent may be used as long as it is able to dissolve a cellulose acylate to make a dope that may be cast to form a cast film. Preferred examples of such a chlorine containing organic solvent include dichloromethane and chloroform, with dichloromethane being particularly preferred. The chlorine containing organic solvent may be used in combination with any chlorine-free organic solvent. In that case, however, it is desirable to use dichloromethane in a proportion of at least 50% by mass based on the total organic solvent system. Suitable organic solvents that may be used in combination with the chlorine containing organic solvent include C3-C12 esters, C3-C12 ketones, C3-C12 ethers, alcohols, and hydrocarbons. The esters, ketones, ethers, and alcohols may have a cyclic structure. Compounds having any two or all of an ester, a ketone, and an ether functional group (—O—, —CO—, and —COO—) are also useful solvents. The solvent may further have other functional groups such as an alcoholic hydroxyl group. In using a solvent having two or more functional groups, the total carbon atom number of the solvent is in the range recited above.

Examples of the C3-C12 esters are ethyl formate, propyl formate, pentyl formate, methyl acetate, ethyl acetate, and pentyl acetate. Examples of the C3-C12 ketones are acetone, methyl ethyl ketone, diethyl ketone, diisobutyl ketone, cyclopentanone, cyclohexanone, and methylcyclohexanone. Examples of C3-C12 ethers include diisopropyl ether, dimethoxymethane, dimethoxyethane, 1,4-dioxane, 1,3-dioxolane, tetrahydrofuran, anisole, and phenetol. Examples of organic solvents having functional groups of two or more kinds are 2-ethoxyethyl acetate, 2-methoxyethanol, and 2-butoxyethanol.

The alcohols that can be used in combination with the chlorine containing organic solvent may be straight-chain, branched, or cyclic and are preferably saturated aliphatic alcohols. The alcoholic hydroxyl group may be primary, secondary, or tertiary. Examples of the alcohols include methanol, ethanol, 1-propanol, 2-propanol, 1-butanol, 2-butanol, t-butanol, 1-pentanol, 2-methyl-2-butanol, and cyclohexanol. Fluoroalcohols, such as 2-fluoroethanol, 2,2,2-trifluoroethanol, and 2,2,3,3-tetrafluoro-1-propanol, are also included in usable alcohol solvents. The hydrocarbons that can be used in combination with the chlorine containing organic solvent may be straight-chain, branched, or cyclic and may be aromatic or aliphatic. The aliphatic hydrocarbons may be saturated or unsaturated. Examples of the hydrocarbons include cyclohexane, hexane, benzene, toluene, and xylene.

Other useful solvents include those described in JP 2007-140497A.

A cellulose acylate solution may be prepared in a usual manner including treating the solvent and solute at temperatures of 0° C. or higher, i.e., room temperature or high temperatures. The solution preparation is carried out using the method and apparatus commonly employed to prepare a dope in ordinary solvent casting. When the solution is prepared in a usual manner, it is recommended to use as an organic solvent a mixture of a halogenated hydrocarbon (particularly dichloromethane) and an alcohol (particularly methanol, ethanol, 1-propanol, 2-propanol, 1-butanol, 2-butanol, t-butanol, 1-pentanol, 2-methyl-2-butanol, or a cyclohexanol).

The cellulose acylate is dissolved preferably in a concentration of 10% to 40% by mass, more preferably 10% to 30% by mass. Any one or more of necessary additives hereinafter described may previously be added to the organic solvent as a main solvent.

The solution is prepared by stirring a cellulose acylate and an organic solvent at ambient temperature (i.e., 0° to 40° C.). Pressure and/or heat may be applied during stirring in preparing a high concentration solution. Specifically, a cellulose acylate and an organic solvent are sealed in a pressure vessel and stirred under pressure at or above the boiling point at atmospheric pressure of the solvent and below the boiling point at the applied pressure of the solvent. The heating temperature is usually 40° C. or higher, preferably 60° C. to 200° C., more preferably 80° C. to 110° C.

The components of the solution may previously be mixed before being put into the vessel or may successively put into the vessel. The vessel should be configured to stir the contents. An inert gas such as nitrogen may be introduced to pressurize the vessel. The vessel may be pressurized by making use of the increase in vapor pressure of the solvent by the heat. The components may be introduced under pressure into the vessel after the vessel is closed.

When heat is applied, the vessel is preferably heated from the outside. For example, a jacketed vessel for heating may be used, or the vessel may be placed on a plate heater having piping through which a heating liquid is circulated to heat the whole vessel. The vessel is preferably equipped with a stirring blade. The stirring blade is preferably long enough for its tip to nearly reach the inner wall of the vessel. The stirring blade preferably has a scraper at the tip thereof to constantly renew the liquid film on the inner wall of the vessel. The vessel may be equipped with instruments such as a pressure gauge and a thermometer. The cellulose acylate and the additive are thus dissolved in the solvent in the vessel. The prepared dope is cooled either as it is in the vessel or after it is taken out of the vessel using, e.g., a heat exchanger.

The resulting dope is formed into a cellulose acylate film by solvent casting. A retardation increasing agent is preferably added to the dope.

Solvent casting is carried out by casting the dope on a metal substrate in a drum or belt form and allowing the solvent to evaporate to form a cast film. The concentration of the dope to be cast is preferably adjusted to 5% to 40% by mass. The surface of the substrate is preferably mirror finished. The substrate surface temperature is preferably 30° C. or lower, more preferably 20° C. or lower, even more preferably 0° C. or lower, most preferably −10° C. to 0° C. The film forming techniques taught in JP 2000-301555A, JP 2000-301558A, JP 7-32391A, JP 3-193316A, JP 5-086212A, JP 62-037113A, JP 2-276607A, JP 55-014201A, JP 2-111511A, and JP 2-208650A can be made use of.

The dope cast on the metal substrate is dried usually by blowing hot air to the metal substrate (a drum or a belt), i.e., the exposed side of the web on the metal substrate or to the inner side of the drum or belt, or applying a temperature-controlled liquid to the inner side of the drum or belt (i.e., the side opposite to the casting side) to heat the drum or the belt by heat transfer and control the surface temperature. The liquid heat transfer method is preferred. The surface temperature of the metal substrate before casting is not limited as long as it is below the boiling point of the solvent used in the dope. To promote the drying and the loss of fluidity of the dope on the metal substrate, nevertheless, it is preferred to set the substrate surface temperature lower than the lowest boiling point of the solvents used in the dope by 1° C. to 10° C. This does not apply, however, to the case where the cast dope is peeled after cooling without drying.

The Re and Rth values of the cellulose acylate film can also be controlled by the temperature of the metal substrate on which the dope is cast and the temperature and amount of drying air applied to the dope film on the substrate. In particular, Rth is largely influenced by the drying conditions on the metal substrate. As the substrate temperature rises, as the temperature of the drying air applied to the dope film rises, or as the amount of the drying air increases, namely, as the amount of heat applied to the dope film increases, Rth decreases. Conversely, the lower the amount of heat, the higher the Rth. Rth is particularly greatly influenced by the drying conditions during the first half of the drying period from immediately after casting up to stripping from the substrate.

With respect to the drying techniques that can be used in the solvent casting, reference can be made, e.g., to U.S. Pat. Nos. 2,336,310, 2,367,603, 2,492,078, 2,492,977, 2,492,978, 2,607,704, 2,739,069, and 2739070, British Patents 640731 and 736892, JP 45-4554B, JP 49-5614B, JP 60-176834A, JP 60-203430A, and JP 62-115035A. The dope film on the belt or drum may be dried by blowing air or an inert gas such as nitrogen.

Stripping the resulting film from the belt or drum may be followed by further drying with hot air at a temperature sequentially increasing from 100° C. to 160° C. to remove the residual solvent as taught in JP 5-17844B. This technique allows for reducing the time from casting to stripping. To implement the technique, it is necessary for the dope to gel at the drum or belt surface temperature at the time of casting.

Two or more layers may be formed by multi-layered casting using the prepared cellulose acylate solution (dope). In this case, the cellulose acylate film is preferably made by solvent casting that is carried out by casting the dope on a drum or a belt and allowing the solvent to evaporate to form a cast film. The concentration of the dope to be cast is preferably adjusted to 10% to 40% by mass. The surface of the drum or the belt is preferably mirror finished.

In the case of the multi-layered casting, it is possible to cast two or more cellulose acylate solutions. Multi-layered casting may be carried out by casting the dopes through the respective dies provided at spacing in the moving direction of the substrate. The techniques described in JP 61-158414A, JP 1-122419A, and JP 11-198285A can be utilized. Multi-layered casting may also be performed by co-casting two dopes through the respective die slots as described, e.g., in JP 60-27562B, JP 61-94724A, JP 61-947245A, JP 61-104813A, JP 61-158413A, and JP 6-134933A. The solvent casting technique proposed in JP 56-162617A is also useful, in which a flow of a high viscosity cellulose acylate dope is surrounded by a flow of a low viscosity cellulose acylate dope, and the two dopes are simultaneously extruded onto a substrate.

The technique disclosed in JP 44-20235B is also useful, in which a cast film formed by casting a first dope on a substrate from a first die is stripped, and a second dope is cast from a second die onto the cast film on the side that has been in contact with the substrate.

The two or more cellulose acylate dopes used in multi-layered casting may be either the same or different. To impart functions to two or more cellulose acylate layers, cellulose acylate dopes appropriate for the respective functions may be extruded from the respective die slots. It is possible to cast the cellulose acylate dope simultaneously with other functional layers (for example, an adhesive layer, a dye layer, an antistatic layer, an anti-halation layer, a UV absorbing layer, and a polarizing layer).

To achieve a required film thickness by single layer casting, it is necessary to extrude a high-concentration, high-viscosity cellulose acylate dope. Such a dope has poor stability and tends to form solid matter, which can often cause machine trouble or results in formation of a cast film with poor surface smoothness. The above-described multi-layered casting technique provides a solution to this problem. Since a plurality of highly viscous dopes are cast from the respective die slots on a metal substrate simultaneously, the resulting cast film exhibits excellent surface properties such as improved smoothness. Furthermore, use of thick cellulose acylate dopes contributes to a decrease in drying load and an increase of production speed.

The thus obtained cellulose ester film preferably has a width of 1400 to 4000 mm, more preferably 1400 to 2500 mm, and a length (wound per roll) of 300 to 10000 m, more preferably 1000 to 8000 m, even more preferably 1000 to 7000 m.

The thickness of the cellulose ester film is preferably 10 to 80 more preferably 35 to 65 Thicknesses of 10 μm or greater are preferred in terms of handling properties in processing into a polarizing plate or other element and prevention of curling. The variation in thickness of the cellulose ester film is preferably within 2%, more preferably within 1.5%, even more preferably within 1%, in both the MD and TD.

The cellulose ester film may contain additives other than the non-phosphoric acid additive, such as deterioration inhibitors, UV absorbers, and particulate matting agents. The deterioration inhibitors include antioxidants, peroxide decomposers, radical inhibitors, metal deactivators, acid scavengers, and amines. Details of the deterioration inhibitors are described in JP 3-199201A, JP 5-194789A, JP 5-271471A, and JP 6-107854A. The amount of the deterioration inhibitor to be added is preferably 0.01% to 1%, more preferably 0.01% to 0.2%, by mass based on the dope to obtain sufficient effects of addition while preventing a bleed out of the deterioration inhibitor. Particularly preferred deterioration inhibitors are butylated hydroxytoluene and tribenzylamine.

Examples of suitable UV absorbers include the compounds described in JP 2006-282979A (e.g., benzophenones, benzotriazoles, and triazines). Two or more UV absorbers may be used in combination. Benzotriazole UV absorbers, such as Tinuvin 328, Tinuvin 326, Tinuvin 329, Tinuvin 571, and Adekastab LA-31, are particularly preferred. The amount of the UV absorber to be added is preferably 10% or less, more preferably 3% or less, even more preferably 0.05% to 2%, by mass based on the cellulose ester.

Examples of suitable particulate matting agents include silicon dioxide particles, titanium dioxide particles, aluminum oxide particles, zirconium oxide particles, calcium carbonate particles, talc, clay, calcined kaolin particles, calcined calcium silicate particles, calcium silicate hydrate particles, aluminum silicate particles, magnesium silicate particles, and calcium phosphate particles. Silicon-containing particles are preferred in terms of low cloudiness. Silicon dioxide particles are particularly preferred. Silicon dioxide particles preferably have an average primary particle size of 20 nm or smaller and an apparent specific gravity of 70 g/L or more. To reduce the haze of the film, the average primary particle size is more preferably as small as 5 to 16 nm. The apparent specific gravity is more preferably 90 to 200 g/L, even more preferably 100 to 200 g/L. Particles with a greater apparent specific gravity are dispersible in a higher concentration without agglomeration to provide a film with a reduced haze Preferred embodiments of the usage of the particulate matting agents are described in Journal of Technical Disclosure 2001-1745, published on Mar. 15, 2001 by Japan Institute of Invention and Innovation, pp. 35-36, which is preferably applied to the cellulose ester film of the invention.

The cellulose ester cast film is preferably subjected to stretching to adjust the degree of alignment or the retardation characteristics. Positive stretching in the width direction (TD) is proposed as disclosed, e.g., in JP 62-115035A, JP 4-152125A, JP 4-284211A, JP 4-298310A, and JP 11-48271A.

The stretching is carried out at room temperature or under heating. The heating temperature is preferably from (Tg−20)° C. to (Tg+100)° C., where Tg is the glass transition temperature of the film. Stretching at a temperature extremely lower than the Tg can cause a break of the film, resulting in a failure to obtain desired optical characteristics. When the film is stretched at a temperature extremely higher than the Tg, the molecular alignment resulting from the stretching may be relaxed by the heat before being thermally set, resulting in a failure to obtain desired optical characteristics.

The film may be stretched uniaxially either in the MD or TD or biaxially. Biaxial stretching may be conducted either simultaneously or successively. In the case of biaxial stretching, it is preferred that the stretch ratio in the TD be higher than that in the MD. The stretch ratio in the TD is preferably 1.01 to 2, more preferably 1.10 to 1.5, even more preferably 1.15 to 1.4. The stretch ratio in the MD is preferably 1.01 to 1.10, more preferably 1.02 to 1.05.

The step of stretching may be incorporated into the line of film formation or may be carried out in a separate line on a film unwound from a roll. In the former case, the film as containing a residual solvent may be stretched. The residual solvent content of the film to be stretched in the line of film formation is preferably 0.05% to 50% by mass, the “residual solvent content” being defined to be a value calculated by formula: residual solvent content (%)=(mass of residual volatile content/mass of film after heat treatment)×100. In the latter case, the film is preferably stretched in the TD at a stretch ratio of 1.01 to 2, more preferably 1.10 to 1.5, even more preferably 1.15 to 1.4, with a residual solvent content of 0% to 5%.

The film having been stretched in the line of film formation (first stretching) and would into a roll may further be subjected to stretch treatment (second stretching). In this case, too, the first stretching is preferably conducted on the film with a residual solvent content of 0.05% to 50%, and the second stretching is preferably with a residual solvent content of 0% to 5%. The overall stretch ratio in the TD is preferably 1.01 to 2, more preferably 1.10 to 1.5, even more preferably 1.15 to 1.4.

In a preferred embodiment of stretching, the film is transversely stretched by using a tenter frame in the line of film formation.

When the film is biaxially stretched, the biaxial stretching may be either simultaneous or sequential. Sequential biaxial stretching is preferred from the viewpoint of operational continuity. The film stripped from the belt or drum is stretched first in the TD or MD and then in the MD or TD.

To relax the residual strain after stretching to reduce dimensional change and to reduce the variation of the in-plane slow axis angle along the film width direction, the step of transverse stretching is preferably followed by the step of relaxation. In the relaxation step, the film width is preferably adjusted to 100% to 70% of the film width before the relaxation (relaxation ratio of 0% to 30%). The temperature in the relaxation step is preferably (Tg−50)° C. to (Tg+50)° C. In a usual stretch treatment, the time required for the film having been transversely stretched to the maximum width in the tenter zone to pass through the relaxation zone is shorter than one minute.

The apparent Tg of the film in the stretching step is obtained from a DSC curve determined by sealing the film containing a residual solvent in an aluminum pan and heating the temperature from 25° C. up to 200° C. at a rate of 20° C./min.

The stretched cellulose ester film may be subjected to the step of blowing superheated steam at 100° C. or higher to the film. By the step of blowing superheated steam, the residual stress of the cellulose acetate film is relaxed to minimize dimensional change of the film. The temperature of the steam is not particularly limited when it is 100° C. or higher, but is preferably 200° C. or lower in view of the heat resistance of the film.

The operation from casting to post-drying may be performed in air or an inert gas (e.g., nitrogen) atmosphere.

The resulting cellulose ester film is wound up into a roll using a commonly employed winding machine in accordance with various winding methods including constant tension winding, constant torque winding, taper tension winding, and programmed tension winding (constant internal stress winding).

The cellulose ester film is preferably subjected to a surface treatment, such as a corona discharge treatment, a glow discharge treatment, a flame treatment, an acid treatment, an alkali treatment, or a UV irradiation treatment. To form a primer layer is also a preferred surface treatment as disclosed in JP 7-333433A. The temperature of the cellulose ester film during any of the surface treatments is preferably kept at or below the Tg of the film, specifically at or below 150° C., to retain the planarity of the film.

For use as a protective film of a polarizer, the cellulose ester film is preferably subjected to an acid treatment or an alkali treatment, namely a saponification treatment.

The surface energy of the cellulose ester film is preferably 55 mN/m or higher, more preferably 60 mN/m to 75 mN/m.

Saponification of the cellulose ester film with an alkali is preferably conducted by soaking the film in an alkali solution (e.g., a potassium hydroxide solution or a sodium hydroxide solution), neutralizing the film surface with an acidic solution, washing the film with water, and drying the film. The hydroxide ion concentration of the alkali solution is preferably 0.1 to 3.0 mol/L, more preferably 0.5 to 2.0 mol/L. The temperature of the alkali solution is from room temperature to 90° C., more preferably 40° C. to 70° C.

The surface energy of a solid is determined by the contact angle method, the wet heat method, or the adsorption method as described in Nureno Kisoto Ohyo, Realize Inc., Dec. 10, 1989. The surface energy of the cellulose ester film of the invention is suitably determined by the contact angle method, in which the surface energy of the film is calculated from the contact angles with two liquids whose surface energies are known, the contact angle being defined to be the angle between the tangent of a liquid drop at the intersection with the film surface and the film surface.

In what follows, Re(λ) and Rth(λ) denote an in-plane retardation and a retardation in the thickness direction (hereinafter “thickness direction retardation”), respectively, at a wavelength π. Re is determined for the incidence of light having a wavelength of λ nm in the direction normal to the film surface with a phase difference measurement system KOBRA 21ADH (from Oji Scientific Instruments). Rth is calculated by KOBRA 21ADH based on retardation values determined in three directions: the first is the Re(k) obtained above, the second is a retardation measured for light of a wavelength λ nm incident in a direction tilted (rotated) by +40° with respect to the normal direction of the film around the in-plane slow axis, which axis is decided by KOBRA 21ADH, as an axis of tilt, and the third is a retardation measured for light of a wavelength λ nm incident in a direction titled by −40° with respect to the normal direction of the film surface around the in-plane slow axis as an axis of tilt. The assumed average refractive index and the thickness of the film are also needed for calculation. The assumed average refractive indices of various films are known from Polymer Handbook, John Wiley & Sons, Inc., or catalogs of various optical films. For the films having unknown refractive indices, the refractive indices can be measured with an Abbe refractometer. Exemplary average refractive indices of major optical films are as follows. Cellulose acylate film: 1.48; cycloolefin polymer film: 1.52; polycarbonate film: 1.59; polymethyl methacrylate film: 1.49; and polystyrene film: 1.59. With the assumed average refractive index and the thickness inputted, KOBRA 21ADH calculates nx, ny, and nz of the film, where nx is the refractive index in the in-plane slow axis direction, ny is the refractive index in the in-plane fast axis direction, and nz is the refractive index in the thickness direction.

It is preferred for the cellulose ester film of the invention to have Re and Rth, which are defined by formulae (1) and (2), at 590 nm falling within the respective ranges (3) and (4):

Re=(nx−ny)×d (1)

Rth={(nx+ny)/2−nz}×d (2)

0≦Re≦5 (3)

20≦Rth≦50 (4)

where nx is the refractive index along the in-plane slow axis direction; ny is the refractive index along the in-plane fast axis direction; nz is the refractive index along the film thickness; and d is the film thickness (nm).

A film satisfying the ranges (3) and (4) has small optical anisotropy and is therefore suited for use as a protective film of a polarizing plate. A functional layer may be provided on the cellulose ester protective film. For example, an optically anisotropic layer may be provided for the purpose of improving the display contrast, viewing angle characteristics, or tint of LCDs.

The haze of the cellulose ester film is preferably 0.01% to 2.0%, more preferably 0.05% to 1.5%, even more preferably 0.1% to 1.0%. Transparency is of importance for the film to be used as an optical film. The haze is measured with a haze meter HGM-2DP (from Suga Test Instruments Co., Ltd.) at 25° C. and 60% RH in accordance with JIS K6714.

The transmission of the cellulose ester film is measured on a specimen measuring 13 mm by 40 mm at a wavelength of 300 to 450 nm with a spectrophotometer U-3210 from Hitachi, Ltd. at 25° C. and 60% RH. The wavelength slope width is obtained by subtracting the wavelength at which the transmission is −5% from the wavelength at which the transmission is 72%. The transmission threshold wavelength is defined to be (wavelength slope width/2)+wavelength at which the transmission is 5%. The absorption end is defined to be the wavelength at which the transmission is 0.4%. The transmissions at 380 nm and 350 nm are thus evaluated.

For use as a protective film on the opposite side of a polarizer to a liquid crystal cell, it is preferred for the cellulose ester film to have a spectral transmission of 45% to 95% at 380 nm and of 10% or less at 350 nm.

The cellulose ester film preferably has a Tg of 120° C. or higher, more preferably 140° C. or higher. The Tg of the film is measured by monitoring a sample film in a differential scanning calorimeter while heating the film at a rate of 10° C./min. The temperature which corresponds to the mid-point of the baseline shift due to glass transition is taken as the Tg.

Tg may also be measured using a dynamic viscoelasticity measuring device as follows. A 5 mm wide and 30 mm long specimen cut out of the unstretched cellulose ester film is conditioned at 25° C. and 60% RH for at least 2 hours before measurement. The Tg measurement is made with a dynamic viscoelasticity measuring device Vibron DVA-225 from ITK Co., Ltd. at a sample length between grips of 20 mm, at a heating rate of 2° C./min from 30° to 250° C., and at a frequency of 1 Hz. The storage modulus is plotted on a logarithmic ordinate and temperature (° C.) on a linear abscissa. A straight line 1 and a straight line 2 showing a steep decrease in storage modulus observed at the phase transition from the solid region to the glass transition region are drawn in the solid region and the glass transition region, respectively. The intersection of the lines 1 and 2 indicates the temperature at which the storage modulus starts to decrease abruptly and the film starts to soften, i.e., at which the film begins to be transferred to the glass transition region. This temperature is referred to as the glass transition temperature Tg (dynamic viscoelasticity).

For use as a protective film of a polarizing plate, it is preferred for the cellulose ester film to have an equilibrium water content of 0% to 4%, more preferably 0.1% to 3.5%, even more preferably 1% to 3%, at 25° C. and 80% RH irrespective of the film thickness so as not to impair the adhesion to a water soluble polymer such as polyvinyl alcohol. With an equilibrium water content of 4% or less, the film is prevented from having too much humidity dependence of retardation, which is advantageous for use as a substrate of an optical compensation film. The water content is measured by Karl-Fischer's method on a film specimen measuring 7 mm by 35 mm using a moisture meter CA-03 and a water vaporizer VA-05, both from Mitsubishi Chemical Corp. The measured amount of water (g) is divided by the sample mass (g) to give a water content percentage.

The moisture permeability of the film is determined at 60° C. and 95% RH in accordance with JIS Z0208. Since moisture permeability reduces with an increase in film thickness, it should be normalized to a thickness of 80 μm irrespective of the sample's thickness. The moisture permeability normalized to a film thickness of 80 μm is calculated from formula: measured moisture permeability×measured film thickness (μm)/80 μm.

Moisture permeability measurement is carried out in accordance with the method described in Kobunshi no Bussei II (Kobunshi Jikken Koza 4), Kyoritsu Shuppan, pp. 285-294: Joki Toka Ryo no Sokutei (Shituryo Ho, Ondokei Ho, Jokiatsu Ho, Kyuchaku Ho).

The cellulose ester film preferably has a moisture permeability of 400 to 2000 g/m²·24 hr, more preferably 400 to 1800 g/m²·24 hr, even more preferably 400 to 1600 g/m²·24 hr. With the moisture permeability of 2000 g/m²·24 hr or less, it is possible to avoid such a disadvantage that the absolute value of humidity dependence of the Re and Rth of the film exceeds 0.5 nm % RH.

The cellulose ester film preferably has dimensional stability such that the dimensional change occurring when the film is left to stand at 60° C. and 90% RH for 24 hours (high humidity condition) and that occurring when the film is left to stand at 90° C. and 5% RH for 24 hours (high temperature condition) are both 0.5% or less. The dimensional change in either condition is more preferably 0.3% or less, even more preferably 0.15% or less.

The cellulose ester film is useful as a protective film of a polarizing plate. The polarizing plate of the invention includes a polarizer and a protective film on each side of the polarizer and has the cellulose ester film of the invention as a protective film on at least one side of the polarizer.

For use as a polarizer protective film, the cellulose ester film is preferably hydrophilized by any of the above described surface treatments (also described in JP 6-94915A and JP 6-118232A), such as glow discharge treatment, corona discharge treatment, or alkali saponification. In the case when the cellulose ester of the cellulose ester film is cellulose acylate, alkali saponification is the best surface treatment.

A polarizer may be prepared by, for example, immersing a polyvinyl alcohol film in an iodine solution, followed by stretching. In using the polarizer obtained by immersing a polyvinyl alcohol film in an iodine solution, followed by stretching, the cellulose ester film of the invention may directly be bonded on its surface treated side onto both sides of the polarizer via an adhesive. The polarizing plate of the invention preferably has the cellulose ester film bonded directly to the polarizer as described. The adhesive is exemplified by an aqueous solution of polyvinyl alcohol or polyvinyl acetal (e.g., polyvinyl butyral) or a latex of a vinyl polymer (e.g., polybutyl acrylate). A completely saponified polyvinyl alcohol aqueous solution is the most preferred adhesive.

An LCD generally has the liquid crystal cell disposed between a pair of polarizing plates and therefore contains a total of four polarizer-protective films. While the cellulose ester film of the invention may be used as any one or more of the four protective films, it is particularly advantageous to use the cellulose ester film as the protective film located closest to a viewer of the display. In this application, the protective film closest to a viewer may be, on its viewer's side, laminated with a transparent hardcoat layer, an anti-glare layer, an anti-reflective layer, and so on.

The cellulose ester film and the polarizing plate according to the invention are applicable to LCDs of various display modes. The LCD of the invention includes the polarizing plate of the invention. Examples of the liquid crystal display modes include TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), and HAN (hybrid aligned nematic).

### EXAMPLES

The invention will now be illustrated in greater detail with reference to Examples, but it should be understood that the invention is not deemed to be limited thereto. Unless otherwise noted, all the percents and parts are by mass.

### Preparation of Cellulose Acylates

Cellulose acylates having different degrees of substitution with acetyl group as an acyl group as shown in Table 1 below were prepared. Cellulose was acylated with a carboxylic acid corresponding to the acyl group at 40° C. in the presence of 7.8 parts of sulfuric acid as a catalyst per 100 parts of cellulose. The degree of acyl substitution described was achieved by adjusting the amount of the carboxylic acid to be added. After the acylation reaction, the system was aged at 40° C. Low molecular weight components of the cellulose acylate was removed by washing with acetone.

TABLE 1

| Cellulose | Acyl Group/Degree of | Number Average |
|---|---|---|
| Acylate | Substitution (Raw Material) | Mol. Wt. |
| C-1 | acetyl/2.87 (linter) | 78000 |
| C-2 | acetyl/2.94 | 75000 |
| C-3 | acetyl/2.55 | 70000 |
| C-4 | acetyl/2.86 (pulp) | 62000 |

### Preparation of Dopes

Dopes D-1 through D-17 were prepared by putting the composition shown in Table 2 in a mixing tank and stirring while heating to dissolve the components. In Table 2, the contents of the additive and the particulate matting agent are given in part by mass per 100 parts by mass of the cellulose acylate. The ratios of the solvent system are by mass. The amount of the solvent system was decided to give the solids content (i.e., the total concentration of the cellulose acylate and the additives including matting agent, in the dope) shown in Table 2.

TABLE 2

| | Cellulose | | Particulate Matting | Solvent System | | |
|---|---|---|---|---|---|---|
| Dope | Acylate | Additive (content) | Agent (Content) | Kinds | Ratio | Solids Content |
| D-1 | C-1 | tributyl trimellitate (8) | silica particles (0.05) | dichloromethane/methanol | 87/13 | 19 |
| D-2 | C-1 | tributyl trimellitate (12) | ″ | ″ | 92/8 | 19 |
| D-3 | C-1 | tributyl trimellitate (12) | ″ | ″ | 87/13 | 19 |
| D-4 | C-1 | tributyl trimellitate (20) | ″ | ″ | 87/13 | 19 |
| D-5 | C-1 | tributyl trimellitate (4) | ″ | ″ | 87/13 | 19 |
| D-6 | C-1 | tributyl trimellitate (30) | ″ | ″ | 87/13 | 19 |
| D-7 | C-1 | triisodecyl trimellitate (12) | ″ | ″ | 87/13 | 19 |
| D-8 | C-1 | aliphatic ester oligomer (12) | ″ | ″ | 87/13 | 19 |
| D-9 | C-2 | tributyl trimellitate (12) | ″ | ″ | 87/13 | 19 |
| D-10 | C-4 | aliphatic ester oligomer (12) | ″ | ″ | 87/13 | 19 |
| D-11 | C-3 | tributyl trimellitate (12) | ″ | ″ | 87/13 | 19 |
| D-12 | C-4 | tributyl trimellitate (12) | — | dichloromethane/methanol/1-butanol | 79/20/1 | 24 |
| D-13 | C-4 | triisodecyl trimellitate (12) | — | ″ | 79/20/1 | 24 |
| D-14 | C-2 | tributyl trimellitate (12) | — | ″ | 79/20/1 | 24 |
| D-15 | C-4 | aliphatic ester oligomer (12) | — | ″ | 79/20/1 | 24 |
| D-16 | C-4 | citric ester (12) | — | ″ | 79/20/1 | 24 |
| D-17 | C-4 | TPP/BDP (8/4) | — | ″ | 79/20/1 | 24 |

The compounds used in the preparation of the dopes shown in Table 2 are as follows.

Tributyl trimellitate:

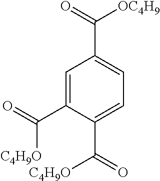

Triisodecyl trimellitate: Trimex T-10, from Kao Corp.
Aliphatic ester oligomer: P-103, from DIC Corp.
Citric ester: (C₆H₅COOCH)₄C
TPP/BDP: mixture of triphenyl phosphate and biphenyldiphenyl phosphate
Silica particles: Aerosol R972, from Nippon Aerosil Co., Ltd.

### Making of Cellulose Acylate Films

### Examples 1 to 11 and Comparative Examples 1 to 4

Each of the dopes prepared above and shown in Table 3 for a basal layer and the dope described below for a surface layer were co-cast uniformly from a casting die on a stainless steel endless belt (substrate) using a belt casting machine with the dope of a basal layer sandwiched between two layers of the dope for a surface layer. At the position where the residual solvent contents in the dopes reduced to 40%, the cast dope was stripped in the form of film from the belt, introduced into a tenter where the film was dried while moving through a drying zone with its lateral edges fixed by the tenter clips. The resulting film was laterally stretched in the tenter to obtain a cellulose acylate film of Examples 1 to 11 and Comparative Examples 1 to 5. The dope used to form the basal layer, the substrate temperature during casting, the transverse stretch ratio, and the width and thickness of the resulting film are shown in Table 3.

### Examples 12 to 14 and Comparative Examples 6 to 8

Each of the dopes prepared above and shown in Table 3 for a basal layer and the dope described below for a surface layer were simultaneously co-cast uniformly from a casting die on a stainless steel drum (substrate) using a drum casting machine with the dope of a basal layer sandwiched between two layers of the dope for a surface layer. At the position where the residual solvent contents in the dopes reduced to 70%, the cast dope was stripped in the form of film from the drum, introduced into a tenter where the film with its lateral edges grasped by the tenter clips was dried while being stretched laterally with the residual solvent content ranging from 3% to 5%. The film was transported by rollers through a heat treating unit where it was further dried to give a cellulose acylate film of Examples 12 to 14. The dope used to form the basal layer, the substrate temperature during casting, the transverse stretch ratio, and the width and thickness of the resulting film are shown in Table 3.

Dope for surface layer: Prepared in the same manner as for the dope for a basal layer, except that the silica particles were added in an amount of 0.05 parts per 100 parts of the cellulose acylate and that the amount of the solvent system was adjusted to result in a solids content of 20%.

TABLE 3

| | | | | | Dimension | |
|---|---|---|---|---|---|---|
| | | | Substrate | | Width | Thickness |
| | Dope | Film Formation Method | Temp. (° C.) | Stretch Ratio | (mm) | (μm) |
| Example 1 | D-1 | solvent casting on belt | 20 | 1.3 | 1490 | 40 |
| Example 2 | D-2 | solvent casting on belt | 20 | 1.3 | 1490 | 40 |
| Example 3 | D-3 | solvent casting on belt | 20 | 1.3 | 1490 | 40 |
| Example 4 | D-3 | solvent casting on belt | 20 | 1.35 | 1490 | 40 |
| Example 5 | D-3 | solvent casting on belt | 20 | 1.38 | 1490 | 40 |
| Example 6 | D-4 | solvent casting on belt | 20 | 1.28 | 1490 | 40 |
| Comp. Example 1 | D-5 | solvent casting on belt | 20 | 1.28 | 1490 | 40 |
| Comp. Example 2 | D-6 | solvent casting on belt | 20 | 1.25 | 1490 | 40 |
| Example 7 | D-7 | solvent casting on belt | 20 | 1.3 | 1490 | 40 |
| Comp. Example 3 | D-8 | solvent casting on belt | 20 | 1.24 | 1490 | 40 |
| Comp. Example 4 | D-10 | solvent casting on belt. | 20 | 1.24 | 1490 | 40 |
| Example 8 | D-11 | solvent casting on belt | 20 | 1.3 | 1490 | 40 |
| Comp. Example 5 | D-12 | solvent casting on belt | 20 | 1.28 | 1490 | 40 |
| Example 9 | D-3 | solvent casting on belt | 20 | 1.2 | 1960 | 40 |
| Example 10 | D-3 | solvent casting on belt | 20 | 1.39 | 2300 | 60 |
| Example 11 | D-3 | solvent casting on belt | 20 | 1.3 | 1490 | 28 |
| Example 12 | D-13 | solvent casting on drum | −9 | 1.28 | 1490 | 40 |
| Example 13 | D-13 | solvent casting on drum | −9 | 1.38 | 1490 | 40 |
| Example 14 | D-14 | solvent casting on drum | −9 | 1.28 | 1490 | 40 |
| Comp. Example 6 | D-15 | solvent casting on drum | −9 | 1.32 | 1490 | 40 |
| Comp. Example 7 | D-16 | solvent casting on drum | −9 | 1.29 | 1490 | 40 |
| Comp. Example 8 | D-17 | solvent casting on drum | −9 | 1.28 | 1490 | 40 |

### Making of Polarizing Plates

Each of the cellulose acylate films of Examples 1 through 14 and Comparative Examples 1 through 8 was immersed in a 1.5N sodium hydroxide aqueous solution at 55° C. for 2 minutes, washed in a room temperature water bath, neutralized with 0.05N sulfuric acid at 30° C., again washed in a room temperature water bath, and dried with 100° C. hot air.

Separately, an 80 μm thick polyvinyl alcohol film in a roll form was unrolled, stretched 5 times in an iodine aqueous solution, and dried to obtain a polarizer film.

A commercially available cellulose acetate film Fuji Tack TD60UL, from Fujifilm Co., Ltd., was alkali-saponified in the same manner as described above. The alkali-saponified cellulose acylate film of Example 1 and the alkali-saponified cellulose acetate film Fuji Tack TD60UL were joined together with the polarizing film therebetween using a 3% aqueous solution of polyvinyl alcohol PVA-117H from Kuraray Co., Ltd. as an adhesive to obtain the polarizing plate having both sides protected by the cellulose acylate films. The slow axis of the cellulose acylate film on each side of the polarizer was parallel with the transmission axis of the polarizer. Similarly, when each of the alkali-saponified cellulose acylate films of Examples 2 to 14 and Comperative Examples 1 to 4 was used, the polarizing plate was obtained in the same manner. Table 4 below shows the performance properties of the cellulose acylate films of Examples 1 through 14 and Comparative Examples 1 through 8 and the performance properties of the polarizing plates made by using the cellulose acylate films.

The performance properties listed in Table 4 were determined and evaluated as follows.

### (1) Degree of Alignment in Thickness Direction

An X-ray diffractometer RAPID R-AXIS available from Rigaku Corp. was used. A specimen measuring 0.3 mm by 5 cm cut out of the cellulose ester film was irradiated on its edge surface with X-ray from CuKα radiation, and an intensity distribution at the 20 angle of 8° was measured by the transmission method, from which the degree of alignment was calculated.

### (2) Elastic Modulus

A specimen measuring 5 mm by 150 mm was cut out of the cellulose ester film. A stress-strain curve of the specimen was determined with a Tensilon tensile tester RTA-100 from Orientec at 25° C. and 60% RH in each of the MD and the TD in accordance with ISO 1184 1983. The elastic modulus of the specimen was obtained from the slope of the curve. An average of the elastic moduluses in the MD and the TD was obtained.

### (3) Retardation

The cellulose acylate film was conditioned at 25° C. and 60% RH for 2 hours before measurement. Retardation was determined using a phase difference measurement system KOBRA 21ADH, from Oji Scientific Instruments, in a low phase difference mode.

### (4) Surface Hardness

A hard coat layer was formed on the cellulose acylate film as described below. The hard coated side of the cellulose acylate film was evaluated for pencil hardness in accordance with JIS K5400. The resulting pencil hardness value was taken as a measure of the surface hardness of the cellulose acylate film. Pencil hardnesses of 3H or higher are preferred.

### Formation of Hard Coat Layer:

A hard coat composition shown below was applied to the cellulose acylate film with a No. 8 bar coater, dried at 100° C. for 60 seconds, and cured by irradiation with ultraviolet light (1.5 kW, 300 mJ) in an atmosphere having a nitrogen concentration of 0.1% or less to form a 6 μm thick hard coat.

### Hard Coat Composition:

| | |
|---|---|
| Photopolymerizable monomer PET 30 | 53.5 parts |
| (a 3:2 (molar ratio) mixture of pentaerythritol | |
| triacrylate and pentaerythritol tetraacrylate, | |
| available from Nippon Kayaku Co., Ltd.) | |
| 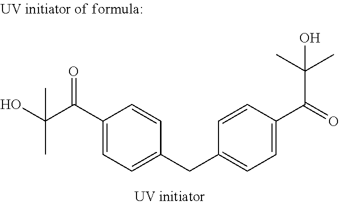 | 1.5 parts |

Solvent (ethyl acetate) to give a solids concentration of 55% was controlled to prepare a hard coat composition.

### (5) Punchability (Workability of Polarizing Plate)

The polarizing plate was punched with a Thomson blade. The cut edge surface of the polarizing plate was observed under a microscope and evaluated according to the following rating system.

A: Neither delamination between the polarizer and the cellulose acylate film nor cracking is observed.
B: The number of delamination sites and cracks is two or fewer, and the length of the delamination sites or cracks from the edge is 0.3 mm or shorter.
C: The number of delamination sites and cracks is greater than two or greater, and the length of the delamination sites or cracks from the edge is larger than 0.3 mm.

### (6) Durability

The polarizing plate was allowed to stand at 65° C. and 95% RH for 1000 hours. Durability of the polarizing plate was rated as follows based on the change in degree of polarization (P) between before and after the standing period.

A: The change in P is less than 0.2%.
B: The change in P is 0.2% to less than 0.5%.
C: The change in P is 0.5% or more.

The degree of polarization P was obtained from equation:

P=100×((parallel transmittance-crossed transmittance)/(parallel transmittance+crossed transmittance))^{1/2}

The parallel and the crossed transmittance of a polarizing plate are transmission of a pair of polarizing plates prepared under the same conditions in a parallel and a crossed configuration as measured with a spectrophotometer U-3210 from Hitachi, Ltd.

TABLE 4

| | Performance of Cellulose Acylate Film | | | | | | | | |
|---|---|---|---|---|---|---|---|---|---|
| | | Elastic Modulus | | | Retardation | | | Performance of | |
| | Degree of Alignment | (GPa) | | | (590 nm) | | Surface | Polarizing plate | |
| | in Thickness Direction | MD | TD | Average | Re | Rth | Hardness | Punchability | Durability |
| Example 1 | 0.125 | 3.9 | 4.1 | 4 | 3.2 | 30 | 3H | A | A |
| Example 2 | 0.123 | 3.7 | 4 | 3.9 | 3.1 | 32 | 3H | A | A |
| Example 3 | 0.123 | 3.7 | 4 | 3.9 | 3.1 | 32 | 3H | A | A |
| Example 4 | 0.126 | 3.9 | 4.1 | 4 | 2.9 | 33 | 3H | A | A |
| Example 5 | 0.128 | 3.9 | 4.2 | 4.1 | 3 | 33 | 3H | A | A |
| Example 6 | 0.12 | 3.6 | 3.8 | 3.7 | 2.6 | 32 | 3H | A | A |
| Comp. Example 1 | 0.124 | 3.9 | 4.2 | 4.1 | 2.7 | 25 | 3H | A | C |
| Comp. Example 2 | 0.113 | 3.2 | 3.6 | 3.4 | 3.9 | 33 | 2H | A | A |
| Example 7 | 0.124 | 3.8 | 4 | 3.9 | 3.1 | 31 | 3H | A | A |
| Comp. Example 3 | 0.116 | 3.5 | 3.6 | 3.6 | 1.8 | 4 | 2H | A | C |
| Comp. Example 4 | 0.115 | 3.3 | 3.7 | 3.5 | 1.9 | 3 | 2H | A | C |
| Example 8 | 0.125 | 3.8 | 4.2 | 4.1 | 1.9 | 23 | 3H | A | A |
| Comp. Example 5 | 0.124 | 3.3 | 3.6 | 3.5 | 4.2 | 45 | 2H | A | B |
| Example 9 | 0.12 | 3.8 | 4.2 | 3.9 | 2.1 | 30 | 3H | A | A |
| Example 10 | 0.127 | 3.9 | 4.2 | 4.1 | 2.9 | 41 | 3H | A | A |
| Example 11 | 0.128 | 3.9 | 4.1 | 4 | 1.8 | 11 | 3H | A | A |
| Example 12 | 0.138 | 4.1 | 4.4 | 4.3 | 3.5 | 30 | 3H | A | A |
| Example 13 | 0.146 | 4.2 | 4.7 | 4.5 | 4.6 | 34 | 3H | B | A |
| Example 14 | 0.14 | 4.2 | 4.6 | 4.2 | 4.3 | 12 | 3H | A | A |
| Comp. Example 6 | 0.146 | 4.5 | 4.9 | 4.7 | 5.2 | 34 | 3H | C | A |
| Comp. Example 7 | 0.136 | 3.5 | 3.6 | 3.6 | 3.6 | 27 | 2H | A | A |
| Comp. Example 8 | 0.133 | 3.4 | 3.6 | 3.5 | 3.8 | 31 | 2H | A | B |

As can be seen from the results in Table 4, the cellulose acylate films of the invention exhibit high surface hardness and, when used as a protective film for a polarizer, provide polarizing plates with excellent workability and durability.

What is claimed is:

1. A cellulose ester film comprising a non-phosphoric acid additive,
wherein the cellulose ester film has: a degree of alignment of 0.12 or higher in a thickness direction of the cellulose ester film as measured by wide angle X-ray diffractometry; and an average elastic modulus of 3.7 to 4.5 GPa.

2. The cellulose ester film according to claim 1, wherein the non-phosphoric acid additive is a trimellitic ester.

3. The cellulose ester film according to claim 1, wherein the non-phosphoric acid additive has a molecular weight of 350 or more.

4. The cellulose ester film according to claim 1, wherein an amount of the non-phosphoric acid additive is 5 to 25% by mass based on the cellulose ester.

5. The cellulose ester film according to claim 1, wherein the degree of alignment in the thickness direction of the cellulose ester film is 0.12 to 0.15.

6. The cellulose ester film according to claim 1, which has a thickness of 10 to 80 μm and a width of 1400 to 4000 mm.

7. The cellulose ester film according to claim 1, which has retardations Re and Rth, which are defined by formulae (1) and (2), at a wavelength of 590 nm falling within respective ranges (3) and (4):
Re=(nx−ny)×d (1)
Rth={(nx+ny)/2−nz}×d (2)
0≦Re≦5 (3)
20≦Rth≦50 (4)
wherein nx is a refractive index in a direction of a slow axis in a plane of the cellulose ester film; ny is a refractive index in a direction of a fast axis in the plane of the cellulose ester film; nz is a refractive index in a thickness direction of the cellulose ester film; and d is a thickness of the cellulose ester film.

8. The cellulose ester film according to claim 1, which comprises a cellulose acylate having a degree of acyl substitution of 2.80 to 2.96.

9. A process for producing a cellulose ester film according to claim 1, comprising forming a film from a solution containing a cellulose ester and a non-phosphoric acid additive on a metal substrate having a surface temperature of 0° C. or lower.

10. The process according to claim 9, further comprising stretching the film 1.15 to 1.4 times in a direction perpendicular to a film moving direction.

11. A polarizing plate comprising a polarizer and protective films on respective sides of the polarizer, at least one of the protective films being a cellulose ester film according to claim 1.

12. A liquid crystal display comprising a liquid crystal cell and two polarizing plates on respective sides of the liquid crystal cell, at least one of the two polarizing plates being the polarizing plate according to claim 11.
